(19) United States
(12) Patent Application Publication
(10) Pub. No.: US 2026/0307952 A1
(43) Pub. Date: Oct. 8, 2026

(54) CRANE WITH TOWER CONNECTION MECHANISM

(71) Applicant: LIFTRA IP APS, Aalborg SV (DK)

(72) Inventors: Per Eske FENGER, Terndrup (DK); Rasmus STENGAARD, Aalborg (DK)

(73) Assignee: LIFTRA IP APS, Aalborg SV (DK)

(21) Appl. No.: 19/477,923

(22) PCT Filed: Apr. 24, 2024
(86) PCT No.: PCT/EP2024/061324

§ 371 Date: Oct. 23, 2025

(30) Foreign Application Priority Data
Apr. 24, 2023 (DK) PA 2023 70194

(51) Int. Cl. B66C 23/20; F03D 13/10

(52) U.S. Cl. CPC B66C 23/207; F03D 13/10

(57) ABSTRACT

A crane (1) connectable to a tower (20) of a wind turbine, wherein the tower (20) comprises a set of one or more crane connection flanges (22) fixed to and extending outwardly from an outer surface (21) of the tower (20) said crane connection flanges of said set of one or more crane connection flanges being arranged circumferentially around the tower and having upper and/or lower engagement surfaces (23), wherein the crane (1) comprises a base portion (10), an arm (31) and at least two flange connection mechanisms (40), said arm (31) extending from the base portion (10) and at least one of said at least two flange connection mechanisms being connected to said arm, wherein said at least two flange connection mechanisms are configured for connecting to a crane connection flange of the set of one or more crane connection flanges (22) of the tower, wherein each of the at least two flange connection mechanisms (40) comprises two cartridges (50), wherein each cartridge (50) comprises at least one upper flange engaging element for engaging an upper engagement surface and/or at least one lower flange engaging element for engaging a lower engagement surface (23) of a crane connection flange of the set of one or more crane connection flanges (22) of the tower; wherein the two cartridges (50) of each flange connection mechanism (40) are separated by a distance (D1) from each other in a horizontal direction, and wherein the flange connection mechanism comprises a vertical load balancing mechanism arranged between the two cartridges such that the vertical forces exerted by the upper and/or lower flange engaging elements of the two cartridges on a flange with which the flange engaging elements of the flange connection mechanism is connected to are the same. In this way, the forces on the flange of the tower will be spread out and balanced.

The present invention relates to a crane with a tower connection mechanism allowing the crane to connect to a tower of a wind turbine such that the crane is supported by the tower of the wind turbine.

### BACKGROUND OF THE INVENTION

When erecting wind turbines and during maintenance of existing wind turbines, a crane typically needs to be provided at the maintenance/construction site. This typically means erecting or building a crane next to the wind turbine. Furthermore, the crane needs to have a vertical extension, which is greater than the height of the wind turbine in order to be able to lift components to the top of the wind turbine. As wind turbines and wind turbine towers continue to grow in size, the cranes must be made ever larger. This is a problem both when transporting cranes to the maintenance/construction site and when setting up the crane. Especially in offshore locations, erecting such large cranes and providing a firm base for them to work from is difficult.

As an alternative to building a crane beside the tower, it is also known to hoist smaller cranes to the top of a wind turbine tower to help with maintenance and repairs. These types of cranes can be called “wind turbine mounted cranes” in contrast to free standing cranes. In this way, rather than erecting a large crane next to the wind turbine tower, the wind turbine tower itself can be used as the main structure of the crane. Examples of such cranes are provided in WO2014/071949 and WO2011/050812. In these examples, the crane is fastened to a mounting fixture located in the nacelle of the wind turbine.

In some cases, a crane can be hoisted to the top of the wind turbine tower with a block and tackle and then clamped to the tower itself via bands or arms which wrap around the tower. In order to be able to support the moments which the crane experiences during the lifting operations, multiple bands or arms are required, the arms being separated by a vertical distance on the tower. When forming the bands or arms, it is important that the bands or arms don't damage the tower structure when clamping onto the tower and when using the crane.

According to this specification, the term “wind turbine mounted crane” should be understood as a crane which is connected to the wind turbine, such that the crane is supported by the wind turbine itself. In certain embodiments, the wind turbine mounted crane is connected to the tower of the wind turbine, at a location somewhere below the nacelle of the wind turbine. These types of cranes could also be called a tower mounted cranes or wind turbine tower mounted cranes, but are still considered wind turbine mounted cranes for the sake of this specification. It should also be noted that the term “wind turbine mounted crane” suggests that the crane is mounted to a wind turbine. However, the scope of protection should cover the crane itself, as the term is used to define that the crane is of the kind which is able to be mounted to a wind turbine, not necessarily that the crane is mounted to a wind turbine.

A wind turbine mounted crane is different than a free standing crane which is located separate from the wind turbine tower, for example a crane which is arranged on the ground next to the wind turbine or floating next to a wind turbine tower on a barge or other floating vessel in an offshore application. In this specification the term free standing crane is used to describe cranes which are not wind turbine mounted cranes. Free standing cranes are sometimes assembled on a crane base foundation mounted on the ground, for example a concrete foundation built on/in the ground. Other examples of free standing cranes are cranes which are driven or sailed to the wind turbine location.

It should be noted that the term “wind turbine tower” should be understood in this specification as a tower for a wind turbine. This could either refer to the final completed tower or to a tower which is in the process of being assembled. For example, a single tower section anchored on the ground, is considered a wind turbine tower under construction according to the current specification. The term “wind turbine tower” as used in the claims should cover this partially assembled wind turbine tower.

WO2017/055598 teaches attaching a crane via a track system which extends up along one side of the wind turbine tower. Thereby, the crane can also be used to assemble the tower itself and “climb” the tower as the tower is built.

Applicant's copending application, published as WO 2020/234435 A1, teaches a self-hoisting crane, which is attached to flanges arranged at end portions of the tower sections of the wind turbine tower.

With increasingly larger wind turbines and towers, the forces acting on the wind turbine tower and the tower sections during attachment and operation of such cranes for hoisting tower elements, hubs, blades etc., becomes ever larger. There is therefore a need for an improved way of attaching a crane to a tower, such as a wind turbine tower, or a tower section thereof.

It is an object of the invention to provide an improved wind turbine mounted crane, configured for being attached to a tower section of a tower, such as a tower of a wind turbine.

It is a further object of the invention to provide a wind turbine mounted crane configured to avoid damaging the tower section and/or connection means on the tower section.

### SUMMARY OF THE INVENTION

The objects of the invention are achieved by a crane according to claim 1. In this way, loads from the connected crane on the tower may be spread out and balanced evenly on multiple points on the tower flange or flanges, to prevent uneven loading on the circumferential flange of the tower section, which could otherwise damage the tower wall.

According to this specification, a vertical load balancing mechanism should be understood as a mechanism which connects two elements such that the vertical loads on the two elements, or the vertical loads exerted by the two elements on an object will be equal. In some embodiments, this could take the form of a hydraulic mechanism with two connected hydraulic cylinders connected in parallel between a common frame and the two elements. In other embodiments, the load balancing mechanism could take the form of a pivot beam connecting the two elements, with the pivot axis being arranged horizontally centered between the two elements. Other embodiments are also covered by the scope of protection of the claims.

In some embodiments, where the set of one or more crane connection flanges of a tower comprises more than one crane connection flange, the crane connection flanges of said set of crane connection flanges are arranged such that the vertical distance between any two of said crane connection flanges of said set of crane connection flanges is less than 1 m, less than 50 cm or less than 25 cm. In some embodiments, where the set of one or more crane connection flanges of a tower comprises more than one crane connection flange, the crane connection flanges of said set of crane connection flanges are arranged such that the flanges are arranged essentially coplanar. In some embodiments, the set of one or more crane connection flanges of a tower, comprises a single flange extending circumferentially around the outer circumference of the tower.

In some embodiments, both cartridges of a flange connection mechanism comprise only upper flange engaging element(s). In some embodiments, both cartridges of a flange connection mechanism comprise only lower flange engaging element(s). In some embodiments, both cartridges of a flange connection mechanism comprise both upper and lower flange engaging elements.

In some embodiments, the vertical load balancing mechanism of the flange connection mechanisms comprises a main frame and the cartridges are connected to the main frame and the main frame is arranged pivotably about a main frame horizontal pivot axis relative to the base portion and/or the arm to which the flange connection mechanism is connected, and where the main frame horizontal pivot axis of each flange connection mechanism is arranged between the two cartridges of the flange connection mechanism. In some embodiments, the main frame horizontal pivot axis is arranged perpendicular to the distance which the two cartridges are separated from each other in a horizontal direction.

In some embodiments, a flange connection mechanism is connected to the base portion and a flange connection mechanism is connected to the arm. In some embodiments, no flange connection mechanism is connected to the base portion.

In some embodiments, the arm is a first arm and the crane further comprises a second arm, and a flange connection mechanism is connected to the first arm and a flange connection mechanism is connected to the second arm. In some embodiments, two flange connection mechanisms are connected to the first arm and two flange connection mechanisms are connected to the second arm. In some embodiments, the first arm is rotationally connected to the base portion about a vertical axis; and the second arm is rotationally connected to the base portion about a vertical axis. In some embodiments, the first arm vertical pivot axis and the second arm vertical pivot axis are arranged parallel to each other and offset from each other. In some embodiments, the base portion, the first arm and the second arm are arranged in a horizontal plane.

In some embodiments, at least one flange connection mechanism comprises a lower flange engaging element which engages a lower engagement surface of a crane connection flange of the set of one or more crane connection flanges and at least one flange connection mechanism comprises an upper flange engaging element which engages an upper engagement surface of a crane connection flange of the set of one or more crane connection flanges. In some embodiments, the flange connection mechanism which engages with the upper engagement surface is closer to the base portion of the crane than the flange connection mechanism which engages with the lower engagement surface.

In some embodiments, a cartridge of a flange connection mechanism comprises a set of flange engaging elements comprising an upper flange engaging element engaging an upper engagement surface and a lower flange engaging element engaging a lower engagement surface. In some embodiments, depending on the load of the crane, the upper flange engaging element or the lower flange engaging element is not physically engaged with the upper or lower engagement surface of the flange respectively.

In some embodiments, the set of flange engaging elements are opposing flange engaging elements. In some embodiments, the opposing flange engaging elements are arranged vertically inline with each other. In some embodiments, the set of flange engaging elements is a set of opposing teeth comprising an upper tooth and a lower tooth. In some embodiments, an opening is provided between the upper tooth and the lower tooth of each of said at least one set of opposing teeth, and wherein each cartridge comprises a tooth displacement mechanism configured for adjusting a height of the opening between the upper tooth and the lower tooth of each of said at least one set of opposing teeth.

In some embodiments, the upper and lower teeth of each of said at least one set of opposing teeth are arranged as elongated members pivotably connected to the cartridge about parallel horizontal axes. In some embodiments, the tooth displacement mechanism is pivotably arranged in the cartridge about a tooth displacement mechanism horizontal pivot axis. In some embodiments, where the upper and lower teeth of said at least one set of opposing teeth are arranged as pivotably arranged elongated members, said tooth displacement mechanism horizontal pivot axis is arranged perpendicular to a plane comprising longitudinal axes of the upper and lower teeth of said at least one set of opposing teeth. In some embodiments where a cartridge comprises more than one set of opposing teeth, the tooth displacement mechanism horizontal pivot axis is arranged perpendicular to a plane which is an average plane comprising longitudinal axes of the upper and lower teeth of the more than one set of opposing teeth.

In some embodiments, at least one cartridge comprises a set of two flange engaging elements which are separated from each other horizontally and wherein said cartridge comprises a vertical load balancing mechanism connected between the two flange engaging elements. In some embodiments the two flange engaging elements of the set of two flange engaging elements engage the same side of the crane connection flange of the tower. In some embodiments, the load balancing mechanism comprises a cartridge pivot beam connected to the two flange engaging elements, and wherein the cartridge pivot beam is pivotably arranged about a horizontal cartridge pivot beam axis. In some embodiments, the set of two flange engaging elements comprise two sets of opposing teeth, wherein each cartridge comprises an upper cartridge pivot beam connected to upper teeth of said two sets of opposing teeth and a lower cartridge pivot beam connected to lower teeth of said two sets of opposing teeth, and wherein the upper and lower cartridge pivot beams are pivotably arranged about horizontal upper and lower cartridge pivot beam axes respectively. In some embodiments, the connection between the upper cartridge pivot beam and the upper teeth allows pivotable motion between the upper cartridge pivot beam and the upper teeth and the connection between the lower cartridge pivot beam and the lower teeth allows pivotable motion between the lower cartridge pivot beam and the lower teeth. In some embodiments, the connection is formed by a ball and socket connection.

In some embodiments, the cartridge comprising a set of two flange engaging elements comprises an additional set of two flange engaging elements and an additional vertical load balancing mechanism between the two flange engaging elements of said additional set of two flange engaging elements and in that said cartridge comprises an additional broader vertical load balancing mechanism arranged between the two vertical load balancing mechanisms of the two sets of two flange engaging elements. In this way, four flange engaging elements are provided and the vertical loads exterted by and on each of the four flange engaging elements will be the same. In some embodiments, the additional broader vertical load balancing mechanism between the two vertical load balancing mechanisms comprises a broader pivot beam arranged between the two vertical load balancing mechanisms, said broader pivot beam being pivotably arranged about a horizontal axis arranged between the two vertical load balancing mechanisms in a horizontal direction. In some embodiments, each cartridge comprises an additional two sets of opposing teeth, the additional two sets of opposing teeth being connected to upper and lower cartridge pivot beams as with the first two sets of opposing teeth, and wherein the upper and lower cartridge pivot beams of the additional two sets of opposing teeth are connected to the upper and lower cartridge pivot beams of the first two sets of opposing teeth by an broader upper cartridge pivot beam and a broader lower cartridge pivot beam respectively, the broad upper and lower cartridge pivot beams being pivotably arranged about horizontal broader upper and lower cartridge pivot beam pivot axes. In some embodiments the upper and lower cartridge pivot beam axes and the broader upper and lower pivot beam axes of a cartridge are parallel to each other. In some embodiments, the tooth displacement mechanism is arranged to displace the upper and lower cartridge pivot beams relative to each other and/or the broader upper and lower pivot beams relative to each other. In some embodiments, where the cartridges comprise at least one set of opposing teeth, the openings between the at least one set of opposing teeth of each cartridge of a flange connection mechanism are aligned in a horizontal plane which includes the horizontal main frame pivot axis.

In some embodiments, the flange engaging elements of a cartridge, when there are more than one flange engaging element, are arranged along a curve in a horizontal plane. In this way, the flange engaging elements will be closer to a curved outer surface of a tower section. This will reduce the distortion of the flange.

In some embodiments, each of the two cartridges of a flange connection mechanism are pivotably connected to a main frame of the flange connection mechanism about cartridge vertical axes. In some embodiments, the cartridge vertical axes of the two cartridges are separated by a horizontal distance. In some embodiments, each flange connection mechanism is pivotably connected to an arm about a flange connection mechanism vertical axis. In some embodiments, the cartridge vertical axes of the two cartridges are arranged parallel to each other and on either side of the flange connection mechanism vertical axis. In some embodiments, each flange connection mechanism comprises a biasing mechanism which biases the flange connection mechanism into a biased position relative to the arm to which it is connected to. In some embodiments, the biasing mechanism comprises at least one spring. In some embodiments, the biasing mechanism pivots the flange connection mechanism about a horizontal axis.

In some embodiments, the crane further comprises an arm locking mechanism, said arm locking mechanism comprising a released state where a distal end portion of the arm is freely displaceable with respect to the base portion and a locked state where the distal end portion of the arm is locked with respect to the base portion. In some embodiments where the crane comprises a first arm and a second arm, the arm locking mechanism is arranged between the first arm and the second arm such that in the released state, the distal end portion of the first arm is freely displaceable with respect to a distal end portion of the second arm and that in the locked state, the distal end portion of the first arm is locked with respect to the distal end portion of the second arm.

In some embodiments, the arm is a first arm and the crane further comprises a second arm, wherein each of the first arm and the second arm comprises an inner link and an outer link, and where each inner link and each outer link comprises a flange connection mechanism, and wherein the inner link and the outer link are pivotably connected to each other about vertical axes. In some embodiments, the first and second arm are pivotably connected to the base portion about vertical axes.

In certain cases, it might be argued that when the flange connection mechanism comprises opposing teeth which clamp onto the circumferential flange of the tower section, any twisting of the teeth could impart twisting actions to the flange. This is not desired. If such undesired twisting actions are experienced, then one could enforce that the teeth do not clamp so hard onto the circumferential flange of the tower section, but rather just balance on or clamp more lightly to the circumferential flange. In this way, the circumferential flange is not twisted, and thereby deformation of the circumferential flange or portions thereof are reduced or prevented. Furthermore, by preventing twisting of the flange, the connection between the crane connection flange and the tower section is prevented from being damaged.

In some embodiments, this could be enforced via a method of connecting a crane to a tower of a wind turbine, wherein the tower comprises a set of one or more crane connection flanges fixed to and extending outwardly from an outer surface of the tower, the one or more crane connection flanges of said set of one or more crane connection flanges being arranged circumferentially around the tower, wherein the crane comprises a base portion and an arm, wherein the arm comprises at least one flange connection mechanism comprising at least an upper flange engaging element and a lower flange engaging element for engaging opposed engagement surfaces of the one or more crane connection flanges of the set of one or more crane connection flanges; wherein a clamping mechanism is provided between the upper and lower flange engaging elements to adjust an opening between the upper and lower flange engaging elements; and wherein the method comprises, bringing the flange connection mechanism into the vicinity of a crane connection flange of the set of one or more crane connection flanges, such that the upper flange engaging element is arranged above the crane connection flange and the lower flange engaging element is arranged below the crane connection flange and adjusting the clamping mechanism such that the vertical force applied by the upper flange engaging element to the flange is at least 2 times larger or 2 times smaller than the vertical force applied by the lower flange engaging element to the flange. In some embodiments, the force is at least 3 times larger or 3 times smaller, 4 times larger or 4 times smaller or 5 times larger or 5 times smaller. In some embodiments, the clamping mechanism is adjusted such that there is a small gap between either the upper flange engaging element and the upper engagement surface of the crane connection flange or between the lower flange engaging element and the lower engagement surface of the crane connection flange. In this case, the force difference between the upper and lower flange engagement elements will be very large, since one of the forces will be zero.

In a separate but related invention, which combines different features of the above described embodiments and which could form the basis of a separate divisional application, a crane is provided which is connectable to a tower of a wind turbine, wherein the tower comprises a set of one or more crane connection flanges fixed to and extending outwardly from an outer surface of the tower said crane connection flanges of said set of one or more crane connection flanges being arranged circumferentially around the tower and having upper and/or lower engagement surfaces, wherein the crane comprises a base portion, a first arm and at least two flange connection mechanisms, said first arm extending from the base portion and comprising at least one of said at least two flange connection mechanisms, wherein said at least two flange connection mechanisms are configured for connecting to the set of one or more crane connection flanges of the tower, wherein each of the at least two flange connection mechanisms are adapted to spread the vertical loading of the flange connection mechanism on the flange between at least two points on the flange separated by a horizontal distance; and in that the crane is arranged such that the crane is connectable to tower sections of different diameters by adjusting the angle between the at least two flange connection mechanisms and/or by adjusting the horizontal distance between the at least two flange connection mechanisms. In some embodiments, both the angle and the horizontal distance are adjustable. Different features described elsewhere in this specification can be combined as would be clear to the person skilled in the art based on the teaching of this specification.

The current invention also discloses a second invention, related to the first, but with a different scope of protection.

It is an object of the second invention to provide a wind turbine mounted crane which can engage with a flange on a tower section in a more flexible way.

These aspects are provided according to the following examples. It should be noted that the features of the following examples can be combined with the features of any one of the features described in combination with the first invention discussed above or the third invention discussed below. The person skilled in the art will be able to provide suitable combinations based on the teachings of this specification.
Example 1. A crane (1) connectable to a tower (20) of a wind turbine,
   wherein the tower (20) comprises a set of one or more crane connection flanges (22) fixed to and extending outwardly from an outer surface (21) of the tower (20) said crane connection flanges of said set of one or more crane connection flanges being arranged circumferentially around the tower,
   wherein the crane comprises a base portion, a first arm and a second arm extending from the base portion, said first arm and second arm being configured for connecting the base portion to a set of one or more crane connection flanges of a tower,
   wherein each of the first arm and the second arm comprises a flange connection element,
   wherein each flange connection element is pivotally connected to the respective first arm or second arm about vertical axes. In some embodiments, the flange connection elements are flange connection mechanisms as described above.

This allows the arms and the flange connection elements to fit better around a circular tower section, and to avoid that outer portions of the flange connection elements would be arranged farther out on the flange (relative to the tower wall), which would create a larger bending moment at those locations, and thereby potentially damage the circumferential flange and/or the tower wall by an unevenly distributed moment. It also allows the same flange connection elements to adapt to different diameters of tower sections. In a typical turbine tower, the tower is assembled from a number of tower sections which taper such that the diameter at the top is less than the diameter at the bottom. As the crane moves up the tower, the diameter of the tower sections will therefore decrease. As such, as the crane moves up the tower, the crane will have to clamp onto flanges having successively smaller diameters.

In some examples the one or more crane connection flanges of the set of one or more crane connection flanges of a tower have upper and lower engagement surfaces.
Example 2. A crane according to example 1,
   wherein each of the first arm and the second arm comprises at least two flange connection elements separated by a horizontal distance,
   wherein each of the flange connection elements are pivotably connected to the respective first arm or second arm about vertical axes.
Example 3. A crane according to example 2, wherein each flange connection element is in the form of a jaw which comprises at least one set of opposing teeth for engaging opposed engagement surfaces of a crane connection flange of a set of one or more crane connection flanges of a tower.
Example 4. A crane according to example 3,
   wherein each jaw comprises a main jaw frame, which main jaw frame forms the pivotal connection to the respective first arm or the second arm about the vertical first axis;
   wherein each of the jaws comprises a secondary jaw frame which is pivotally connected to the main jaw frame about a horizontal secondary jaw frame pivot axis.
Example 5. A crane according to example 4, wherein each jaw comprises two cartridges connected to the secondary jaw frame; and
   wherein each cartridge comprises at least one set of opposing teeth for engaging opposed engagement surfaces of a crane connection flange of a set of at least one crane connection flanges of a tower and
   wherein the two cartridges of each jaw are separated by a distance from each other in a horizontal direction.

In some examples, the secondary jaw frame pivot axis of each jaw is arranged between the two cartridges.
Example 6. A crane according to example 5, wherein the two cartridges of a jaw are pivotally connected to the secondary jaw frame about vertical cartridge pivot axes.

In some examples, the two cartridges of a jaw are angled relative to each other.

The current specification also discloses a third invention, related to the first and second inventions, but with a different scope.

An object of the third invention is to provide a crane which can engage the tower in a more secure manner.

This object is provided at least in part via a crane according to one or more of examples 10-13. It should be noted that the features of the following examples can be combined with the features of any one of the features described in combination with the first invention or the second invention. The person skilled in the art will be able to provide suitable combinations based on the teachings of this specification.
Example 10. A crane connectable to a tower of a wind turbine,
   wherein the tower comprises a set of one or more crane connection flanges fixed to and extending outwardly from an outer surface of the tower, said crane connection flanges of said set of one or more crane connection flanges being arranged circumferentially around the tower,
   wherein the crane comprises a base portion, a first arm and a second arm extending from the base portion, said first arm and second arm being configured for connecting the base portion to a set of one or more crane connection flanges of a tower,
   wherein the first arm is rotationally connected to the base portion about a vertical axis;
   wherein the second arm is rotationally connected to the base portion about a vertical axis;
   wherein each of the first arm and the second arm comprises at least one flange connection element for engaging a set of one or more crane connection flanges of a tower,
   wherein the crane further comprises an arm locking mechanism, said arm locking mechanism comprising a released state where a distal end portion of the first arm is freely displaceable with respect to a distal end portion of the second arm and a locked state where the distal end portion of the first arm is locked with respect to the position of the distal end portion of the second arm.

It should be noted that depending on the length of the arms or sections thereof and the tower section diameters, the locking mechanism of the arms may not engage at all tower diameters. At large diameters, the arms won't intersect. If the arms should intersect at all tower diameters, they would have to be much longer than in the embodiments shown in the figures and they would be heavier and bend more. At smaller tower diameters, the forces are larger since the “moment” arm supporting the loads of the crane are lower. Also the highest loads on the crane occur when the crane is at the highest position on the tower, for example when lifting the nacelle, the drive-train, the blades, etc. into position. This is also when the diameter of the tower is smallest. Hence, it is most important for the crane to have a strong connection to the tower when it is at the top of the tower.

In some examples, the first arm vertical pivot axis and the second arm vertical pivot axis are arranged parallel to each other and offset from each other. In some examples, the base portion, the first arm and the second arm are arranged in a horizontal plane.
Example 11. A crane according to example 10, wherein said arm locking mechanism comprises a first portion attached to a distal end portion of the first or second arm and a second portion attached to a distal end portion of the second or first arm respectively,
   wherein the first portion comprises an engagement mechanism,
   wherein the second portion comprises a complementary engaging element, and
   wherein the engagement mechanism is arranged to engage with the engaging element in a position locking manner when the arm locking mechanism is in its locked state.
Example 12. A crane according to example 10 or 11, wherein the first portion comprises an opening comprising two opposing surfaces facing each other and the second portion comprises a protrusion which is insertable into the opening, said protrusion having two corresponding surfaces facing the two opposing surfaces of the opening when the protrusion is inserted into the opening, and where the opposing surfaces of the opening and/or the corresponding surfaces of the protrusion are displaceable perpendicular to the surfaces to change a dimension of a gap between facing surfaces when the protrusion is inserted into the opening.
Example 13. A crane according to example 12, wherein the protrusion and/or the opening comprises a wedge member which is arranged to be displaceable parallel to the facing surfaces.

In some examples, the crane is arranged such that the second arm wedge member is configured to wedge into the first arm wedge member in such a way that they do not clamp together when engaged, but only engage in a locking relationship due to friction when the base portion is subjected to a load.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1, in a perspective view, shows a crane of the self-hoisting type on a tower section, the crane comprising a boom arranged on a base portion, and the base portion being connected to the tower section by a tower connection mechanism according to the invention;

FIG. 2, in a perspective view, shows a detailed view of the crane connected to the tower section of FIG. 1;

FIG. 3, in a perspective view, shows a crane connected to a tower section as in FIGS. 1 and 2, where one arm of the crane has been hidden to show a flange formed on the tower section and portions of the tower connection mechanism according to the invention;

FIG. 4 shows a detail of the crane connected to the tower section of FIG. 3 according to the circle IV in FIG. 3;

FIG. 5a, in a side sectional view, shows a tower section with a circumferential flange and portions of a tower connection mechanism of a crane according to the invention, where the teeth of the connection mechanism are arranged on opposite surfaces of the circumferential flange;

FIG. 5b, in another side sectional view, shows the crane of FIG. 5A, where the teeth of the connection mechanism are more separated than in FIG. 5A and not engaging the opposite surfaces of a circumferential flange of a tower section;

FIG. 6, in a perspective view, shows a crane as in FIGS. 1-5, where one arm of the crane as well as the tower section have been hidden to show jaws of the tower connection mechanism of the crane according to the invention;

FIG. 7, in a top view, shows a crane having two arms, whereon a set of four jaws of a tower connection mechanism of a crane according to the invention is arranged;

FIG. 8, in a perspective view, shows a crane as in FIG. 6, from a different angle than in FIG. 6, illustrating portions of a locking mechanism according to the invention;

FIG. 9, in a perspective view, shows a detail of the locking mechanism seen in FIG. 8 according to the circle IX in FIG. 8;

FIG. 10, in a perspective view, shows a jaw of the connection mechanism according to the invention, the jaw seen from the side facing the tower section when connected;

FIG. 11 shows an enlarged view of the jaw of FIG. 10, with parts of a frame removed to show internal parts of the jaw;

FIG. 12, in a top view, shows the jaw of FIGS. 10-11;

FIG. 13, in a front view, shows the jaw of FIGS. 10-12;

FIG. 14, in a side view, shows the jaw of FIGS. 10-13;

FIG. 15, show detail of the jaw of FIG. 14, with parts of a frame removed to show internal parts of the jaw;

FIG. 16, in a perspective view, shows the jaw of the connection mechanism of FIGS. 10-15, the jaw seen from the side facing away the tower section when connected, i.e. the opposite side as compared to FIG. 10;

FIG. 17, shows an enlarged view of the jaw of FIG. 16 with parts of a frame removed to show details located inside the frame;

FIG. 18, in an exploded perspective view, shows the jaw of FIGS. 10-17;

FIGS. 19a-b, in schematic sectional side views, schematically illustrate a connection between a flange of a tower section and opposing teeth of a connection mechanism, where the teeth are connected too tightly causing the flange to deform (FIG. 19b) when the crane deforms due to loading;

FIGS. 20a-b, in schematic sectional side views, illustrate a connection between a flange of a tower section and one embodiment of opposing teeth of a connection mechanism, again showing the effect on the flange when the crane deforms due to loading (FIG. 20b); and

FIGS. 21a-b, in schematic sectional side views, illustrate a connection between a flange of a tower section and another embodiment of opposing teeth of a connection mechanism, again showing the effect on the flange when the crane deforms due to loading (FIG. 21b); and

FIGS. 22a-b, in schematic sectional side views, illustrate a connection between a flange of a tower section and another embodiment of opposing teeth of a connection mechanism, where the teeth are provided with connection members, again showing the effect on the flange when the crane deforms due to loading (FIG. 22b).

### DETAILED DESCRIPTION OF THE EMBODIMENTS

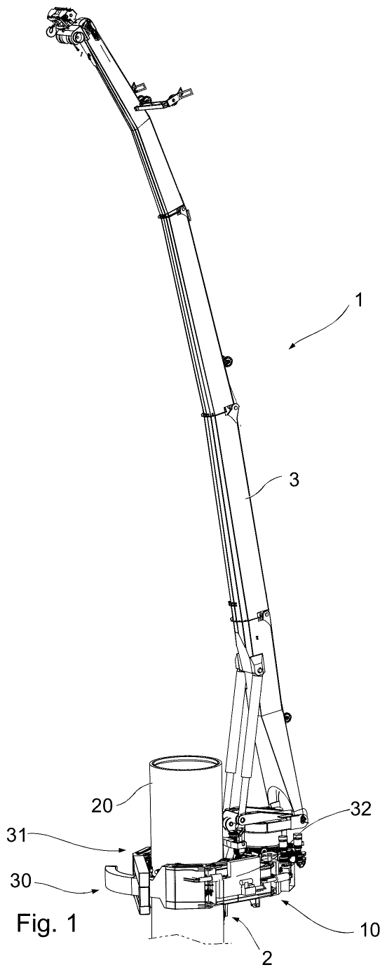

FIG. 1, in a perspective view, shows a crane 1 according to the invention. The crane 1 is attached to an upper portion of a tower section 20.

The shown crane 1 is of the self-hoisting type and self climbing type, and is connectable to a tower section 20. The tower section is in this example a tower section of a wind turbine tower.

By self-hoisting and self climbing is meant that the crane 1 may form part of a crane system allowing the crane 1 to at least partly hoist itself up along a wind turbine tower as the wind turbine tower is being erected from wind turbine tower sections, or that the crane 1 may hoist itself up an existing wind turbine tower (not shown). Examples of self-hoisting cranes are known in the art and will not be described in further detail here. It is emphasized that the crane 1 according to the invention need not be a self-hoisting crane. For example, the crane may be elevated to a position on the wind turbine tower or tower section by another crane (not shown). The inventions in this specifications mainly relate to the interface between the crane and the tower section, with focus on the crane and the novel tower connection mechanism of the crane.

The crane 1 comprises a base portion 10, and a lifting boom 3 pivotably connected to the base portion 10, and extending upward from the base portion 10. However, for the sake of this current invention, the details of the lifting boom are not so relevant and the lifting boom, the mechanisms related to the lifting boom and the lifting wires, etc will not be described in detail in this specification, as they are not so important for the current inventions described in this specification.

The base portion 10 of the crane is connectable to the tower section 20 by a tower connection mechanism 2 according to the invention. This connection mechanism 2 comprises a set of arms 30, a first arm 31 and a second arm 32, as will be described in further detail below. The base portion 10, the first arm 31 and the second arm (32) are arranged in a horizontal plane.

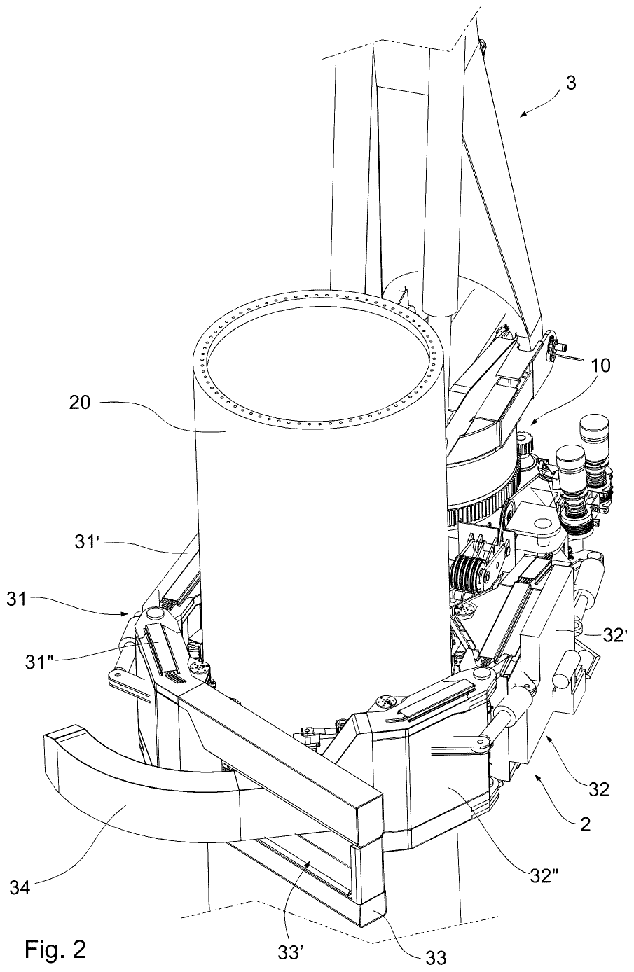

FIG. 2, in a perspective view, shows the crane 1 of FIG. 1 in more detail, and from a slightly different angle. From FIG. 2 it may be appreciated that the first arm 31 and the second arm 32 may be segmented into joints or links rotatably connected to each other.

Thus, the first arm 31 comprises an inner (or proximal) link 31′ and an outer (or distal) link 31″. The inner link 31′ is rotatably connected to the base portion 10 about a vertical axis. Further the inner link 31′ and the outer link 31″ are rotateably interconnected to each other about another vertical axis.

At the distalmost end of the outer link 31″ of the first arm 31, a first arm wedge member 33 is provided. The first arm wedge member 33 is fixed to the end of the outer link 31″. The wedge member 33 functionality will be described in more detail below.

Actuators, in this embodiment hydraulic cylinders, are provided to control the relative rotation between the base portion 10 and the inner link 31′ and between the inner link 31′ and the outer link 31″.

Thereby, the first arm 31 may form an articulated arm. The arm could be considered to have a “shoulder joint” between the base portion and the inner link and an “elbow joint” between the inner link and the outer link.

Similarly, the second arm 32 comprises an inner (or proximal) link 32′ and an outer (or distal) link 32″. The inner link 32′ is rotatably connected to the base portion 10 about a vertical axis. Further the inner link 32′ and the outer link 32″ are rotateably interconnected to each other about another vertical axis.

At the distalmost end of the outer link 32″ of the second arm 32, a second arm wedge member 34 is provided. The second arm wedge member is arranged as a fixed part of the outer link 32″ and rotates with the outer link 32″.

Actuators, in this embodiment hydraulic actuators, are provided to control the relative rotation between the base portion 10 and the inner link 32′ and between the inner link 32′ and the outer link 32″.

Thereby, the second arm 32 also may form an articulated arm. Again, it can be considered that the second arm 32 has a shoulder and an elbow joint as with the first arm.

When the first arm 31 and the second arm 32 are articulated, it allows the arms to interact to hold around a tower section, to thereby allow a plurality of flange connection mechanisms, or jaws (see below), on the first and second arms 31, 32 to interact with a circumferential flange, provided on the tower section 20. When the plurality of jaws engage the circumferential flange the crane 1 can be connected to the tower section 20.

In certain embodiments (not shown), the first arm wedge member 33 on the first arm 31 and the second arm wedge member 34 are optional, however, they can contribute to the strength of the connection between the crane and the tower in certain situations and for certain sizes of crane, load and tower section diameter as will be described in more detail below.

In the embodiments, where the crane 1 comprises a first arm wedge member 33 and a second arm wedge member 34, and as shown in e.g. FIGS. 1 and 2, the first arm wedge member 33 and the second arm wedge member 34 are configured for interacting to attach the first arm 31 and the second arm 32 to each other on a distal side of the tower section relative to the base portion 10 of the crane 1. Preferably, this attachment is made in a way, such that the first arm wedge member 33 and the second arm wedge member 34 do not lock unnecessarily hard to each other, during normal use, but the attachment can be made such that the locking effect increases when the crane is exposed to unevenly distributed loads, caused by the crane center of gravity being located away from the center of the tower section 20. This will ensure that the locking effect is most pronounced when it is most needed. When the crane returns to a more evenly distributed load, the locking effect will be reduced, allowing the crane arms to also detach from each other when it is desired to detach the crane from the tower section.

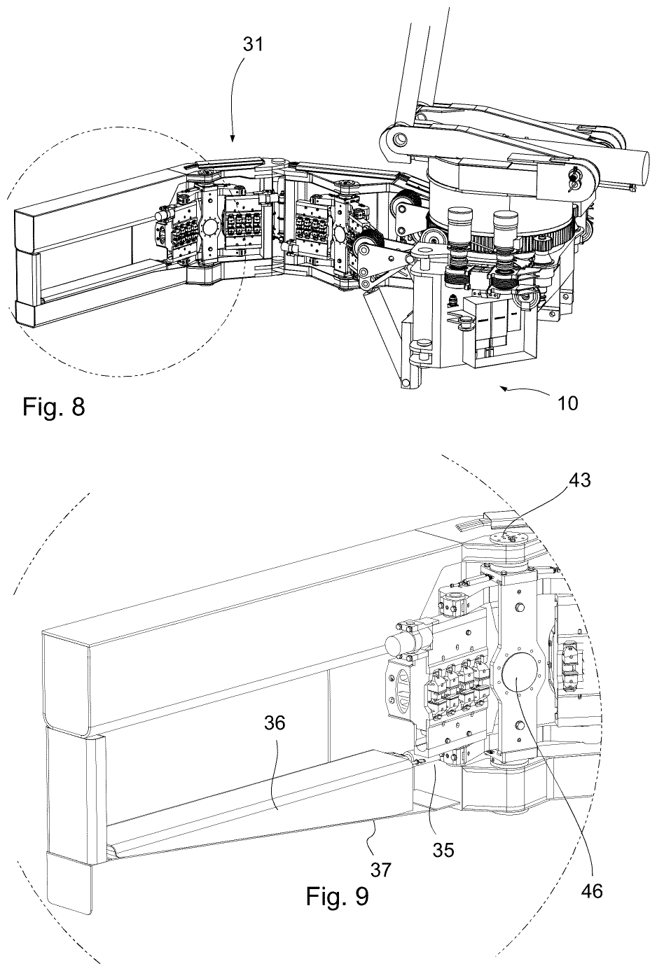

The first arm wedge member 33 may be formed with an opening 33′ configured for receiving the second arm wedge member 34 in the form of a protrusion or beam. Further details of the interaction between the first arm wedge member and the second arm wedge member are described below in connection with FIGS. 8 and 9.

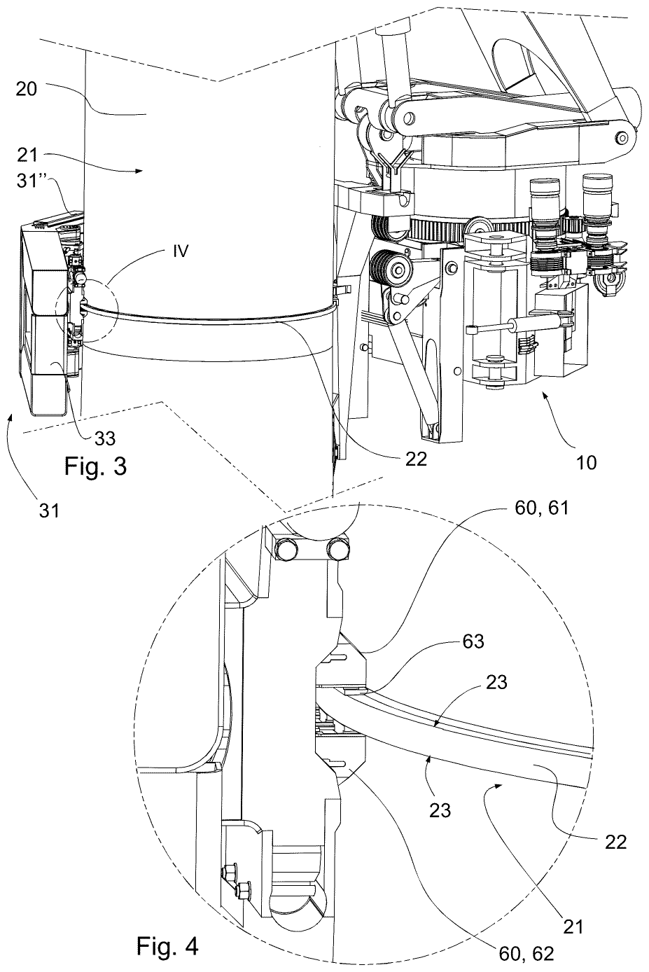

FIG. 3, in a perspective view, shows the crane 1 of FIGS. 1 and 2. In FIG. 3 the second arm 32 has been hidden to show details of the connection mechanism 2 for connecting the crane 1 to the tower section 20. For this purpose, the tower section is provided with a circumferential flange 22. Also shown in FIG. 3 are a set of opposing teeth 60, which form a part of a connection mechanism 2 according to the invention. In some embodiments, the circumferential flange 22 may be considered to form part of the connection mechanism 2. Together the flange and the connection mechanism of the crane could be said to provide a crane tower engagement interface.

In either case, preferably, tower sections 20 for the wind turbine tower may be provided with one or more such circumferential flanges 22. The circumferential flanges 22 may be provided at various positions along the longitudinal extent of the lower sections 20, where it is desirable to be able to (temporarily) place a crane 1. Such, location may be at or close to an upper end of a tower section 20 as shown in FIGS. 1 and 2. In most embodiments, the circumferential flange will be placed at an upper end of the tower section. The circumferential flange can then be made as an integral part of the already existing flange which is used to bolt two adjacent tower sections together. For more details of how the crane can be used to erect a wind turbine, please refer to applicants co-pending application, filed 24.Apr..2023 with the title “Wind turbine mounted crane”.

FIG. 4 shows a detail view of the crane 1 and the tower section of FIG. 3. It will be appreciated that the tower section 20 has a cylindrical or conical wall with an outer or outwardly facing surface 21. The circumferential flange 22 is fixed to and extends outwardly from the outer surface 21 of the tower section 20. It should be noted that the flange shown in the figures is a flange which is arranged at a distance from the end of the tower section. As mentioned above, most flanges will be located at the end of the tower section. The current flange is placed at a distance, since the tower section shown in the figures is the uppermost section of the tower of the wind turbine tower and the next component that is to be lifted up is the nacelle which needs to be placed on top of the tower. Hence, the crane is mounted to a flange located slightly below the top of the tower to make room for the nacelle. For more details, please refer to applicant's copending application, filed 24.Apr..2023 with the title “Wind turbine mounted crane”, which is incorporated by reference in its entirety.

The circumferential flange 22, in this embodiment, extends from the outer surface in a horizontal plane. The circumferential flange 22 has opposed engagement surfaces 23, an upper or upwardly facing surface, and a lower or downwardly facing surface, when the tower section is in upright (vertical) position.

In the embodiment shown in the figures, the flange is shown as a single annular flange extending around the entire circumference of the tower section. However, within the scope of the invention, instead of a single annular flange, it would also be possible to provide multiple shorter flanges spaced around the circumference of the tower section. Knowing the size of the crane and the size of the tower section, the tower sections can be prepared with suitable shorter flanges located as necessary.

Also shown in FIG. 4, the connection mechanism 2 comprises a set of opposing teeth 60 configured for interacting with the engagement surfaces 23 of the circumferential flange 22 to connect the crane 1 to the tower section 20, the opposed teeth being provided in a jaw mechanism (described below) arranged on an arm 30 of the crane 1, in the FIG. 4 embodiment on the outer link 31″ of the first arm 31. Instead of opposing teeth, other forms of flange engaging elements could be provided. Likewise, instead of being opposing elements, one could imagine situations where the engaging elements are not directly opposing each other, but are spaced apart.

It can also be noted that when the crane is actuated with the boom of the crane extending over the tower section, the loading applied by the crane via the the flange connection mechanisms of the crane on the crane connection flange of the tower will be mainly downwards by the flange connection mechanisms located close to the base portion and upwards by the flange connection mechanisms located farther away from the base portion. If the crane boom is limited to this type of loading, instead of having opposed teeth, it would be enough to have upper flange engagement elements on the flange connection mechanisms close to the base portion and lower flange engagement elements on the flange connection mechanisms further away from the base portion.

However, in the current embodiment, since the boom can rotate to many different positions, each of the first arm 31 and the second arm 32 comprises a plurality of such opposed teeth arranged in the same horizontal plane along a longitudinal direction of each of the first arm 31 and the second arm 32, as described in further detail below.

As will be appreciated from FIG. 4, each set of teeth 60 comprises an upper tooth 61 and a lower tooth 62. Upper teeth are configured for abutment against the upper surface 23 of the circumferential flange 22. Lower teeth 62 are configured for abutment against the lower surface 23 of the circumferential flange 22.

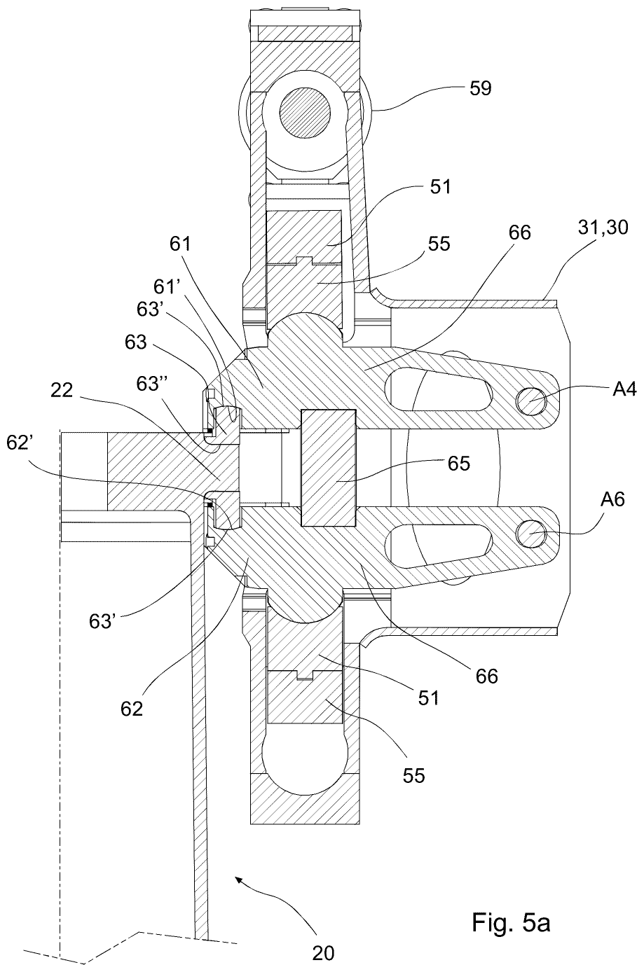

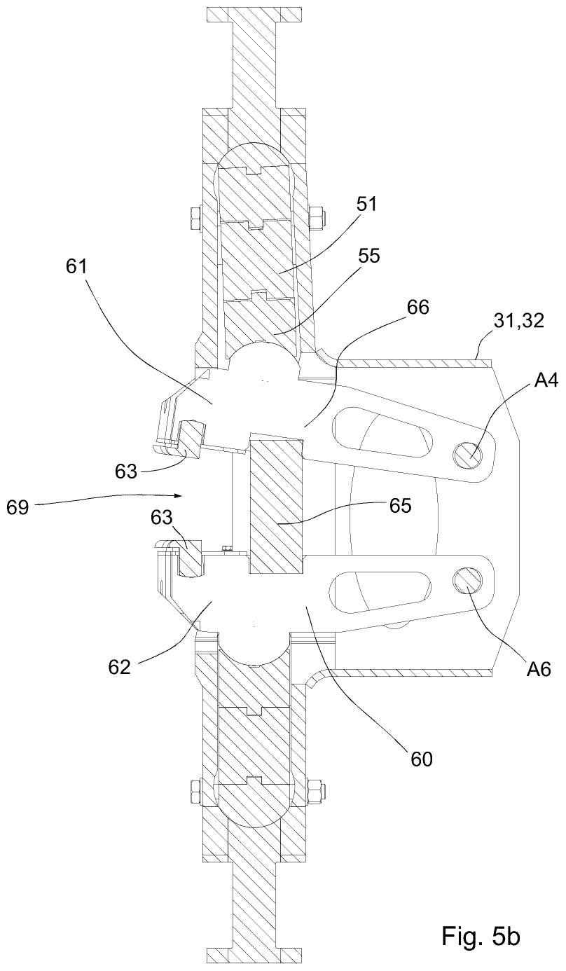

An opening or distance 69 is provided between the upper tooth 61 and the lower tooth 62 of each set 60 of teeth 60, see e.g. FIG. 5b. The height of the opening 69 (or distance between the upper and lower teeth 61, 62) is preferably adjustable, as will be explained below.

The opening 69 is at least large enough to allow the sets of opposed teeth to receive the circumferential flange 22 of the tower section 20.

Also shown in FIGS. 4 and 5a and 5b is that the teeth 61, 62 may be provided with a displaceable contact member 63. It will be appreciated that such a displaceable contact member 63 is optional. The displaceable contact member 63 will be described in more detail below.

FIG. 5a, in a side sectional view, shows a tower section 20 having a circumferential flange 22 as well as portions of a connection mechanism 2 of a crane 1. In this figure, the circumferential flange 22 is located at an extreme end of the tower section 20.

FIG. 5a shows a situation, where a set of opposed teeth 60 of the connection mechanism 2 are engaging opposite engagement surfaces 23 of the circumferential flange 22.

In the embodiment shown in FIG. 5a the upper tooth 61 and the lower tooth 62 are provided with a contact member 63 configured for providing uniform abutment with the engagement surfaces 23 of the circumferential flange 22. This is partly obtained by the contact members 63 interfacing with the upper tooth 61 and the lower tooth 62, respectively, via curved surfaces 61′, 62′ on the teeth 61, 62 cooperating with a curved surface 63′ on the contact member 63. Opposite to the curved surface 63′, the contact members 63 are provided with a planar surface 63″ cooperating with the planar engagement surfaces 23 of the circumferential flange on the tower section 20. As shown schematically in FIGS. 22a-b, when a load is applied to the crane 1 when connected to the tower section 20 as depicted in an exaggerated manner in FIG. 22b, the crane 1 will deform due to the weight of the crane 1 and the teeth of the connection mechanism will pivot relative to the flange. As illustrated in FIG. 22b the cooperating curved surfaces 61′, 62′ on the respective teeth 61, 62, and curved surface 63′ on the respective contact member 63 allows the contact members 63 to rotate relative to the upper tooth 61 and the lower tooth 62, while still maintaining a stable contact between the contact members 63 and the engagement surfaces 23 of the circumferential flange 22.

Hence, it can be said that the contact member is connected to a tooth 61, 62 in such a way that rotation relative to the tooth 61, 62 is allowed. In this way, even when the teeth rotate relative to the flange, the rotation of the teeth are not translated into a twisting of the flange. This prevents a deformation of the crane from twisting the flange unnecessarily.

FIG. 5b, in a side sectional view, shows the connection mechanism of FIG. 5a. The section is taken at a different location than in FIG. 5a in order to better illustrate moments between parts of the connection mechanism 2. However, firstly it may be appreciated that the teeth 61, 62 of the connection mechanism 2 are more separated than in FIG. 5A and not engaging the opposite surfaces of a circumferential flange of a tower section. The tower section 20 or the circumferential flange 22 thereof is not shown in FIG. 5b at all.

FIG. 5b may illustrate a situation before the crane 1 is connected to the tower section 20, when the teeth 61, 62 of the connection mechanism 2 are moved into position to engage the circumferential flange 22 of a tower section 20. FIG. 5a may illustrate the situation after the teeth 61, 62 have been adjusted to engage the circumferential flange 22 of a tower section 20.

As may be appreciated from FIGS. 5a-b, the upper tooth 61 and the lower tooth 62 comprises an elongated body 66. The elongate body 66 of upper tooth 61 is pivotally connected to an arm 31, 32 around an horizontal pivot axis A4, the pivot A4 comprising a hinge arranged at one end of the elongated body 66 of the upper tooth 61 opposite to the end where the upper tooth has a contact surface for engaging the circumferential flange 22 of a tower section 20. Similarly, the elongated body of lower tooth 62 is pivotally connected to an arm 31, 32 around a horizontal pivot axis A6 displaced by a distance relative to the pivot axis A4, the pivot axis A6 comprising a hinge arranged at one end of the elongated body 66 of the lower tooth 62 opposite to the end where the lower tooth 62 has a contact surface for engaging the circumferential flange 22 of a tower section 20. Thereby, the upper and lower teeth 61, 62 of a set of opposed teeth 60 may be rotated towards and away from each other, thereby adjusting the height of the opening 69 between them.

Between the upper and lower teeth 61, 62 of a set of opposed teeth 60 an elastic member 65 is provided. The elastic member 65 may be a spring such as coil spring or other suitable spring. Alternatively, the elastic member 65 may be a block of rubber, such a synthetic rubber, or any other suitable resilient material. The function of the elastic member 65 is to bias the upper and lower teeth 61, 62 of a set of opposed teeth 60 away from each other, and towards the position shown in FIG. 5b.

As also indicated in FIGS. 5a-b, an actuator 59 may through a wedge system, described in more detail below, provide a force on the upper and lower teeth 61, 62 of a set of opposed teeth 60 to rotate the upper and lower teeth 61, 62 towards each other and towards the position shown in FIG. 5a. When force is released, the elastic member will push the teeth apart again into the position shown in FIG. 5b. More details of the mechanism are provided below.

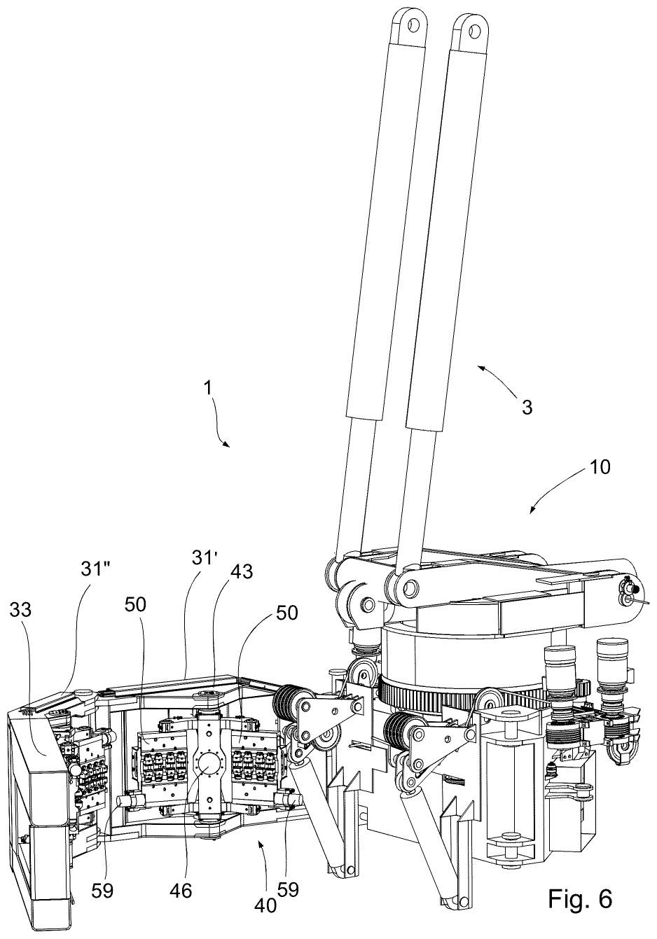

FIG. 6, in a perspective view, shows a crane 1 as in FIGS. 1-5, where one arm of the crane 1 has been hidden to show jaws 40 of the connection mechanism 2, according to preferred embodiments of the invention.

As mentioned above, the crane 1 may connect to a tower section 20 by a plurality of sets of opposing teeth 60 arranged on the arms 31, 32. FIG. 6 illustrates one embodiment of arranging the plurality of sets of opposing teeth 60.

In this embodiment, the plurality of sets of opposing teeth are arranged in cartridges 50, which are arranged in pairs in a jaw 40.

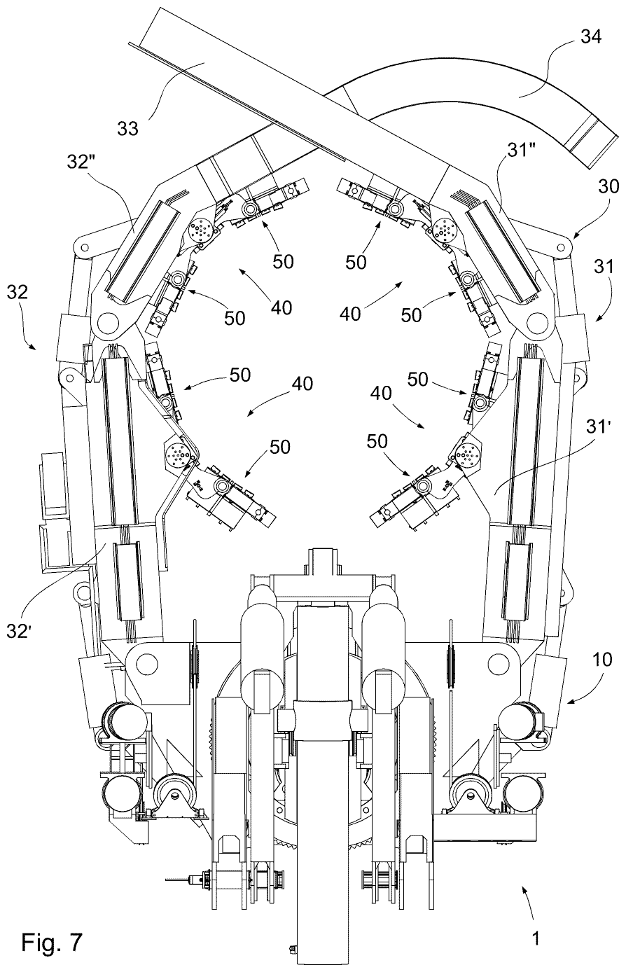

In the current embodiment two jaws 40, or flange connection mechanisms, are arranged on each of the first arm 31 and the second arm 32. An embodiment of this is illustrated in FIG. 7. In other embodiments (not shown) of the invention, a crane could be provided where there is only one jaw, or flange connection mechanism, arranged on each of the first arm 31 and the second arm 32 or a crane could be provided with more than two jaws, or flange connection mechanisms, on each of the first arm 31 and the second arm 32. In another embodiment (not shown), one flange connection mechanism could be provided on the base portion and one flange connection mechanism could be provided on each of two arms.

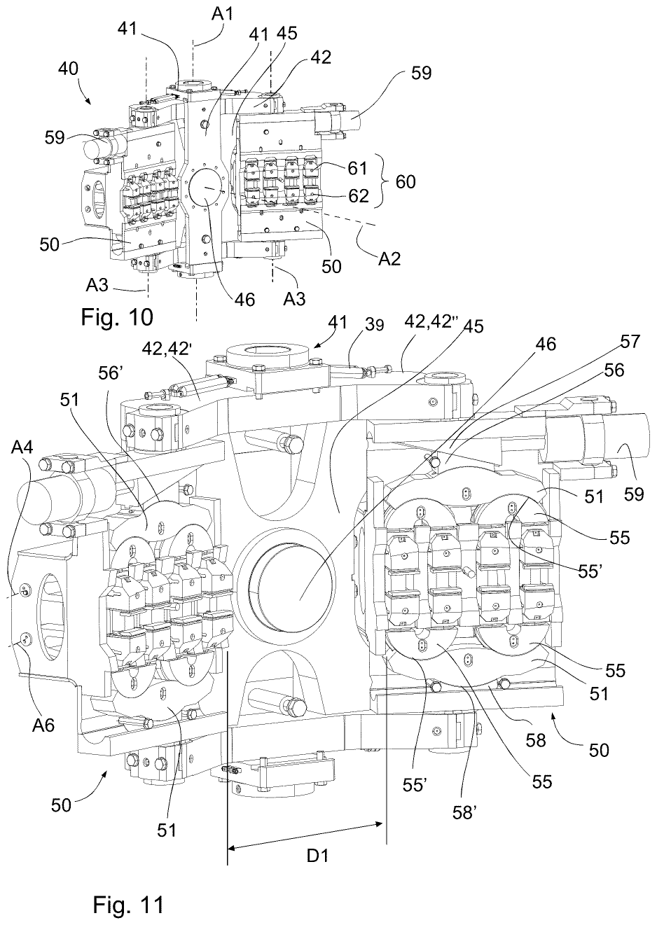

FIG. 7, in a top view, shows a crane 1 having two arms, a first arm 31 and a second arm 32. Two jaws 40 are arranged on each of the first arm 31 and the second arm 32. The first arm 31 and the second arm 32 shown in FIG. 7 each comprises an inner link 31′, 32′ and outer link 32′, 32″. The four jaws 40 of the connection mechanism 2 are arranged on the inner 31′, 32′ and outer links 32′, 32″, one jaw on each link. Furthermore, FIG. 7 clearly shows that each jaw comprises two cartridges 50. Each cartridge comprises four sets of of opposed teeth. This is more clearly shown in FIGS. 10-11.

Referring now to FIGS. 10 and 11, FIG. 10 shows a jaw 40 such as the jaws 40 of FIGS. 6 and 7.

FIG. 10, in a perspective view, shows a jaw 40 of the connection mechanism 2 of the crane according to the invention, the jaw 40 in FIGS. 10 and 11 is seen from the side facing the tower section 20 when connected, thereto. FIG. 11, shows an enlarged view of the jaw 40 of FIG. 10, with parts of a first frame 41 removed to show internal parts of the jaw 40.

The sets of opposing teeth 60 for engaging the opposed engagement surfaces 23 of the circumferential flange 22, are arranged on the jaws.

Each of the jaws 40 is pivotally connected relative to the respective first arm 31 or second arm 32 about a vertical first axis A1. As shown in e.g. FIG. 9 such a pivotal connection may be provided by a first shaft element 43, i.e. vertically arranged shaft, rotationally connected to a main jaw frame 41 of the jaw 40.

Each of the jaws 40 comprises a main jaw frame 41, which main jaw frame 41 comprises the pivotal connection relative to the respective first arm 31 or the second arm 32 about the vertical first axis A1.

As shown in FIG. 11, each of the jaws 40 further comprises a secondary jaw frame 45 and two cartridges 50. The plurality of sets of opposing teeth 60 for engaging the opposed engagement surfaces 23 of the circumferential flange 22 are distributed in the cartridges 50.

As further shown in in FIG. 11, the two cartridges 50 of each jaw 40 are held by the secondary jaw frame 45 and are separated by a distance, D1, from each other in horizontal direction. Further, the secondary jaw frame 45 is pivotally connected relative to the main jaw frame 41 about a horizontal second pivot axis, A2, where the second pivot axis A2 of each jaw 40 is arranged between the two cartridges 50. As shown in e.g. FIG. 10 such a pivotal connection may be provided by a second shaft element 46, i.e. a horizontally arranged shaft. The secondary jaw frame is biased into a neutral position by springs 39 arranged between the main jaw frame 41 and the secondary jaw frame 45.

The first frame 41 comprises two sets of frame arms 42, where each set of frame arms 42 holds a cartridge 50 as shown in FIG. 11.

Each of the cartridges 50 of each jaw 40 is preferably and as illustrated in FIG. 10, pivotally connected to a set of frame arms 42 about a third vertical pivot axis, A3. This allows rotation of the cartridges 40 relative to the main jaw frame 41 of the jaw 40, which allows adjusting the angle of the cartridges 50 so that an inwardly facing surface of each cartridge 50 faces the outer surface 21 of the tower section 20, and ensuring that all set of opposing teeth 60 may be located as close to the outer surface 21 of the tower section 20 as possible. This is especially useful when the crane needs to work on a tower where the tower gets narrower at the top. In this way, the crane can adapt to the different diameters of the tower sections, via the rotations about the vertical axes A1 and A3.

In the current embodiment each cartridge 50 comprises a broad vertical load balancing mechanism configured for adjusting the vertical loading between the two sets of two teeth. As shown in FIG. 11 each broad vertical load balancing mechanism comprises a broad lower pivot beam and a broad upper pivot beam 51. The broad pivot beams 51 are pivotal relative to the secondary jaw frame 45 about a horizontal pivot axis.

This rotation is provided by cooperating curved surfaces 56′ between the broad pivot beam 51 and a first cartridge wedge member 56 for the case of the upper broad pivot beam 51. In the case of the lower broad pivot beam 51, the rotation is provided by cooperating curved surfaces 58′ between the lower broad pivot beam 51 and a frame member 58 of the secondary jaw frame 45.

Further, each cartridge 50 comprises two tooth load balancing mechanisms which are separated from each other horizontally.

As shown each tooth load balancing mechanism comprises an upper tooth pivot beam 55 and a lower tooth pivot beam 55.

Each of the two tooth pivot beams 55 is arranged pivotal relative to the broad pivot beams 51 about a horizontal axis.

This rotation is provided by cooperating curved surfaces 55′ between the upper broad pivot beam 51 and the upper tooth pivot beams 55 for the case of the upper broad pivot beam 51. In the case of the lower broad pivot beam 51, the rotation is provided by cooperating curved surfaces 55′ between the lower broad pivot beam 51 and the lower tooth pivot beams 55.

Further, each upper and lower tooth pivot beam 55 is arranged in the secondary jaw frame 45 such that it is individually vertically translational.

The movement of an upper tooth 61 relative to a lower tooth 62 may be provided as illustrated in FIG. 11 by an actuator 59. The actuator may be an electrical motor or a pneumatic or hydraulic linear actuator. In the FIG. 11 embodiment, the actuator, when extended, pushes on a second cartridge wedge member 57 inducing a horizontal movement therein. The second cartridge wedge member 57 is in contact with the first cartridge wedge member 56. This introduces a vertically downward movement in the first cartridge wedge member 56. The first cartridge wedge member 56 pushes down on the upper broad pivot beam 51, which again pushes down on upper tooth pivot beams 55. Each upper tooth pivot beam 55 pushes down on each of the upper teeth 61. The lower tooth pivot beams 55 and the lower broad pivot beam 51 are kept in place by a frame of the cartridge 50. In this way, an upper tooth 61 and a lower tooth 62 can be moved towards each other to reduce a distance between them, i.e. the height of the opening provided between the upper tooth 61 and the lower tooth 62 of each of the set 60 of opposed teeth. This movement is made against the bias provided by the elastic member 65, arranged between the elongate member 66 of the upper tooth 61 and the elongate member of the lower tooth 62.

It will be appreciated that if the motion of the actuator is reversed, the bias of the elastic member 65 will push the upper tooth 62 and the lower tooth 62 away from each other.

It will also be appreciated, that if a cartridge 50 or a jaw 40 is located adjacent to the circumferential flange 22 without being correctly aligned, i.e. in a way such that some of neighboring upper teeth 61 and/or neighboring lower teeth 62 abut on the circumferential flange 22 before other of the teeth, when the upper and lower teeth are being moved towards each other, then the upper and lower tooth pivot beams 55 and/or the broad upper and lower pivot beams 51 and/or the cartridge 50 and or the jaw will rotate relative to each other in order to align the neighboring teeth and to provide a uniform distribution of vertical forces between the teeth and the circumferential flange, i.e. the relative movement will balance out uneven force distribution, which may e.g. be caused by an uneven weight distribution from the crane, a tilt between the crane 1 and the circumferential flange 20 during mounting, dimensional differences between teeth or flanges, or a tilted position of the jaw or any of its sub-components during mounting of the crane to the circumferential flange 20 of the tower section 20. In the current embodiment, each jaw has 8 sets of opposing teeth and the vertical loads will be distributed evenly between said 8 sets of opposing teeth of each jaw.

It should also be noted that by comparing FIGS. 5a and 5b, it can be seen that as the elongated member of the upper tooth rotates, the position of the connection between the upper tooth pivot beams and the upper teeth displaces horizontally. This would cause the mechanism to bind if not accounted for. Hence, the upper tooth pivot beams and the broad upper pivot beam are arranged pivotably in the cartridge about a horizontal axis essentially parallel to the extension of the actuator 59. In this way, as the tooth rotates upwardly (FIG. 5b), the pivot beams pivot inwardly and as the tooth rotates downwardly, the pivot beams pivot outwardly (FIG. 5a).

It should also be noted that the connection between the teeth and the tooth pivot beams is formed as a type of ball and socket connection which allows the tooth and the tooth pivot beam to move and pivot with respect to each other. While a more rigid connection could be provided if the entire crane structure were stiffer, a stiffer crane would also be much heavier which would require lifting more weight and supporting more weight on the tower section. Hence, reducing the weight of the crane itself is of importance. Reducing the weight, reduces the stiffness, and then the reduction in stiffness can be compensated for in the mechanism by allowing relative motion between the different components.

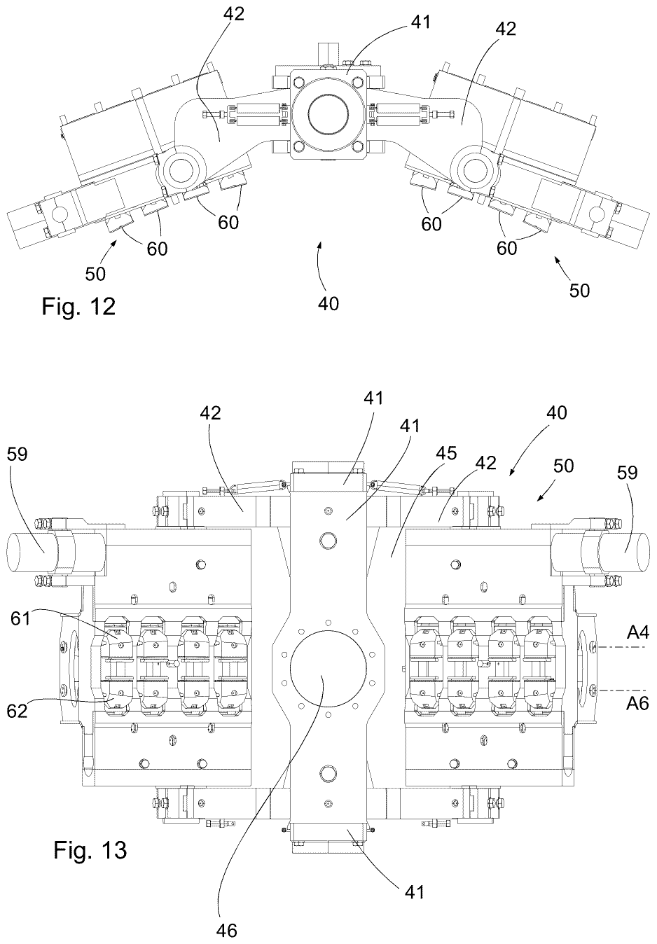

FIG. 12, in a top view, shows the jaw of FIGS. 10-11. As illustrated in FIG. 12 the sets of opposing teeth 60 of each cartridge 50 may be arranged along a curve in the horizontal plane. Thereby, each of the sets of opposed teeth 60 of a cartridge 50 may be brought as close as possible to the outer surface 21 of the tower section 20. Since the tower sections vary in diameter, it is not possible to find a single curvature which is optimal, but a curvature can be chosen which is somewhere between the maximum and minimum tower section diameters. This will provide a good compromise for most situations. In one embodiment (not shown), it would be possible to provide a mechanism to adjust the horizontal position of the teeth relative to the cartridge to compensate for varying tower diameters.

FIG. 13, in a front view, shows the jaw of FIGS. 10-12.

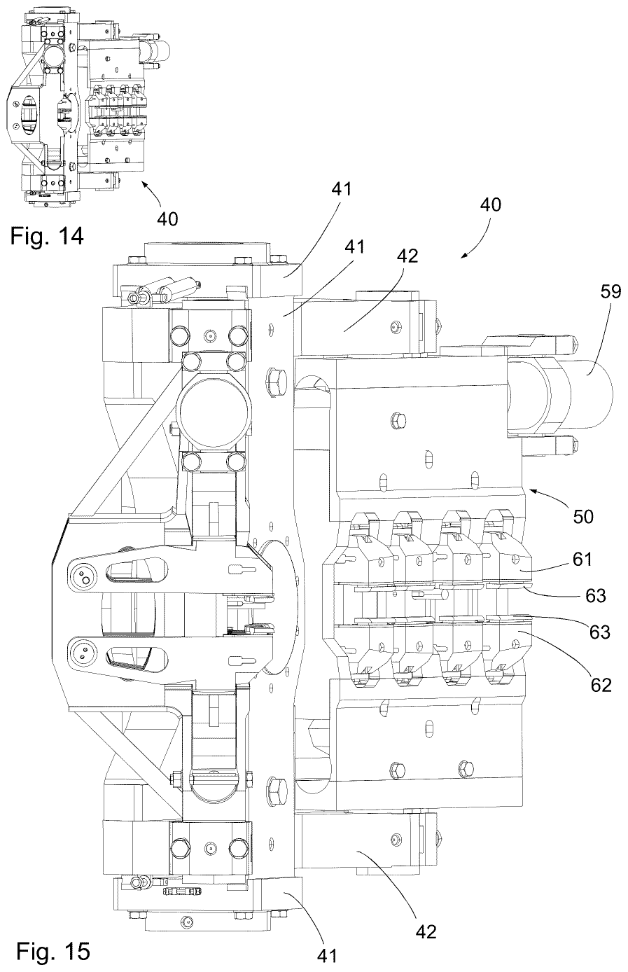

FIG. 14, in a side view, shows the jaw of FIGS. 10-13.

FIG. 15, show detail of the jaw of FIG. 14, with parts of a frame removed to show internal parts of the jaw.

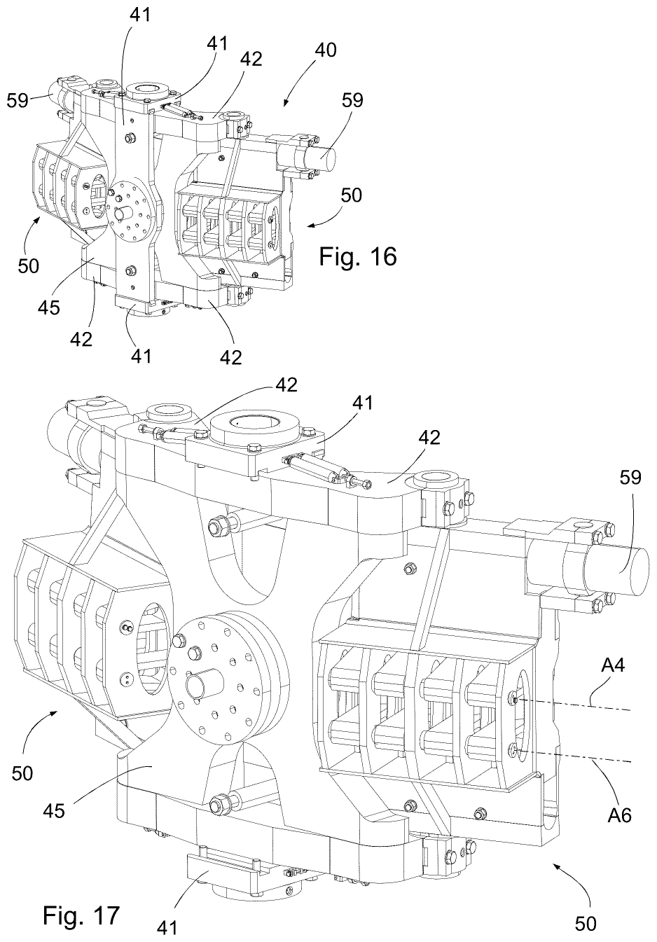

FIG. 16, in a rear perspective view, shows the jaw of the connection mechanism of FIGS. 10-15, the jaw seen from the side facing away the tower section when connected, i.e. the opposite side as compared to FIG. 10;

FIG. 17, shows the jaw of FIG. 16 with parts of a frame removed;

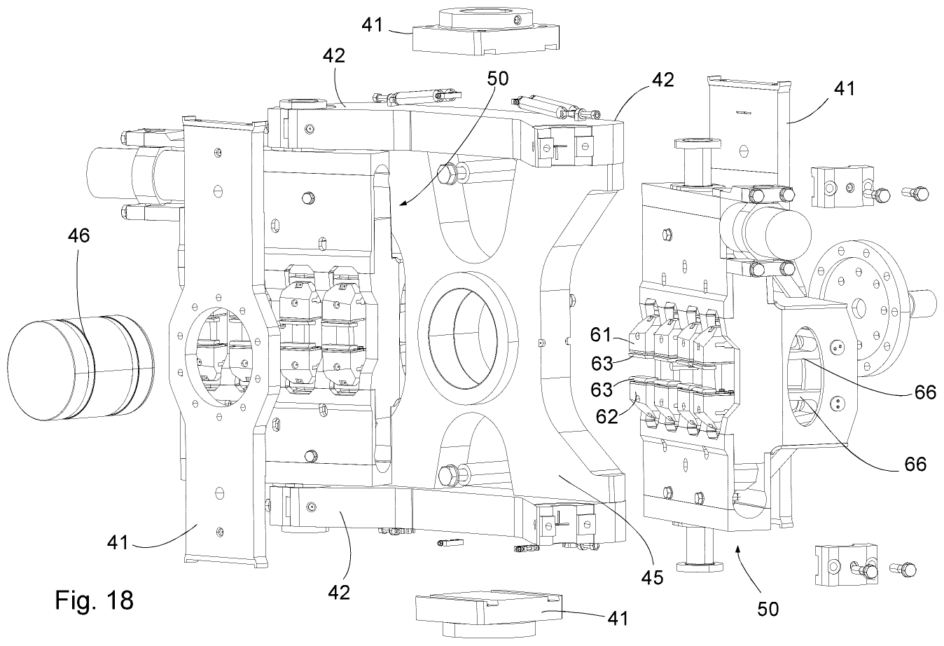

FIG. 18, in an exploded perspective view, shows the jaw of the connection mechanism of FIGS. 10-17;

FIG. 19a schematically shows a connection between a tower section with a flange and a simple embodiment of an opposing tooth embodiment of a connection mechanism, where the jaw is clamped tightly to the flange. When the crane is loaded with a heavy load, the crane will deform due to the heavy loads. Preventing any deformation would require a very sturdy and strong mechanical construction which would be very heavy. Since the crane needs to lift itself and be supported by the tower, it is desired to reduce the weight of the crane as much as possible, hence, the crane will deform when under load. In the case of FIG. 19b, an exaggerated system is shown wherein the opposing teeth are pivoted downwardly due to the deformation of the crane. As can be seen from FIG. 19b, when the opposing teeth are tightly clamped onto the flange, deformation of the crane will be transferred into a twisting of the flange. When an upper tooth 61 and a lower tooth 62 press too tightly against the circumferential flange 22, there is a risk that the circumferential flange becomes weakened and there is a risk that the flange will deform. Deformation of the flange, could lead to deformation and weakening of the sides of the tower section. This could lead to failure of the entire wind turbine tower.

It has been realized that to avoid this deformation, it is not necessary to provide a tight pressure between the circumferential flange 22 and any of the teeth.

Therefore, in one aspect of the invention, the objects of the invention is obtained by a method of controlling the connection between a crane 1 and tower section, such that a squeezing on the circumferential flange 22 is prevented.

The method comprises the steps of bringing the first and second arms 31, 32 into the vicinity of the circumferential flange 22, such that each set 60 of an opposing upper tooth and a lower tooth 61 are arranged with an upper tooth 62 above the circumferential flange 22 and a lower tooth 62 below the circumferential flange 22; and the step of adjusting the height of the opening 69 between the upper tooth 61 and the lower tooth 62 such that they do not exert a clamping pressure on the circumferential flange 22. In principle the upper tooth 61 or the lower tooth, 62 may not contact the contact surface 23 of the circumferential flange at all, e.g. leaving a slight gap between the two. This is illustrated in FIG. 20a-b, where the gap 100 is shown in an exaggerated manner.

From FIG. 20b it will further be appreciated that if a tilt or slight rotation between upper/lower tooth 61, 62 and the circumferential flange 22 is experienced-caused e.g. by an uneven load distribution-edges of a tooth 61, 62 may be forced against surfaces of the circumferential flange or the tower section outer surface 21, thereby forcing the edge into the surface, and potentially damaging the flange and/or the outer wall of the tower section 20. Also, the load on the flange will be moved to the outer portion of the flange, thereby increasing the bending moment applied to the flange by the upper tooth. However, the bending of the teeth will not directly be transferred to the flange due to the gap.

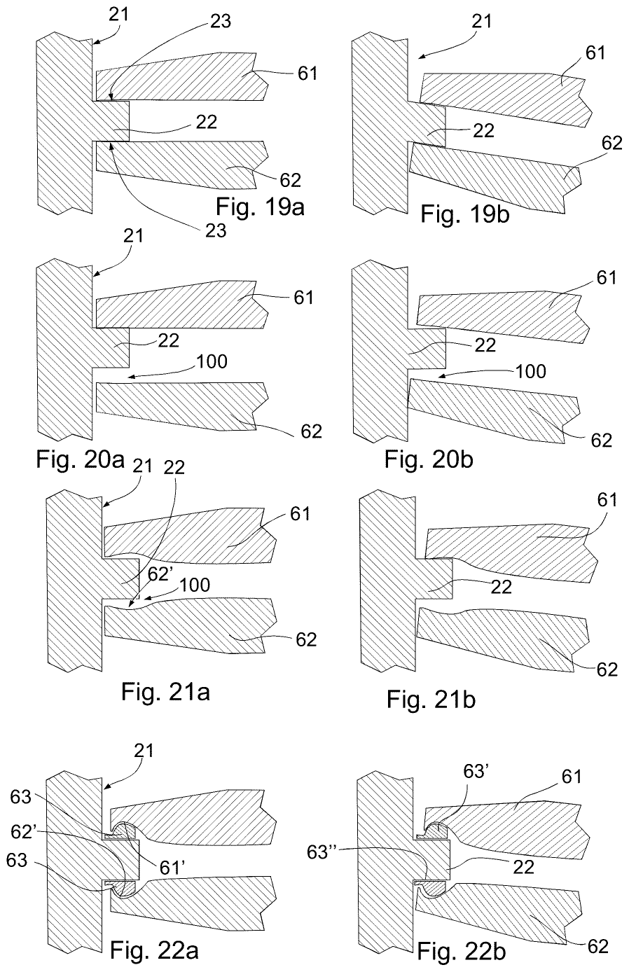

In order to reduce the risk of damage, an upper/lower tooth 61, 62 may be provided with a curved concave abutment surface as illustrated in FIGS. 21a-b. In FIG. 21b it is illustrated that in this case, even when the upper/lower tooth is tilted relative to the circumferential flange 22, the effect of an edge against a contact surface may be reduced. A further improved embodiment, configured for reducing this risk is shown in FIGS. 22a-b, was already described above in connection with FIGS. 5a-b above.

Referring now to FIG. 2 again, as also mentioned above, the arms 31, 32 might be provided with means for connecting the arms 31, 32 to each other on an opposite side of the tower section 20 relative to the base portion 10 of the crane. 1.

These means may comprise a first arm wedge member 33 arranged at a distal end of the first arm, and a second arm wedge member 34 arranged at a distal end of the second arm 32, where the second arm wedge member 34 is configured to wedge into the first arm wedge member 33.

As shown in e.g. FIG. 2, the first arm wedge member 33 may be shaped as a ring comprising a rectangular opening 33′. This rectangular opening 33′ is configured to receive the second arm wedge member 34, e.g. formed as a hook shaped protrusion. The second arm wedge member 34 has upper and lower surfaces configured for slidingly mating with inner upper and lower surfaces of the rectangular opening 33′ in the first arm wedge member 33.

The first arm wedge member 33 is connected to the distal end of the first arm 31 as an extension thereof, and the second arm wedge member 34 is connected to the distal end of the second arm 32 as an extension thereof. The first and second arm wedge members 33, 34 may be rotated against each other and away from each other to provide a connection between the respective distal ends of the first and second arms, in order to secure the connection of the crane 1 to the tower section 20.

Turning now to FIGS. 8 and 9 a mechanism for securing the first arm wedge member 33 to the second arm wedge member 34 is described in detail.

FIG. 8, in a perspective view, shows a crane as in FIGS. 1-7, from a different angle than in FIG. 4, and illustrating portions of a locking mechanism according to the invention. FIG. 9, in a perspective view, shows a detail of the locking mechanism seen in FIG. 8. In FIG. 9, a portion of a casing of the first arm wedge member 33 has been removed to disclose inner components of this locking mechanism. The locking mechanism comprises a linear actuator 35 configured for horizontally sliding an arm wedge 36 against a wedge surface 37 integrated in the first arm wedge member 33. When the linear actuator is extended, it will push the arm wedge 36 horizontally, thereby also causing a displacement in the vertical direction. This reduces the height of the opening 33′. When a second arm wedge member 34 has been inserted in the opening, the arm wedge 36 will clamp against the lower surface of the second arm wedge member to lock the first and second arm wedge members 33, 34 against each other. By reversing the actuator 35, the interlocking first and second arm wedge members may be released from each other. Depending on the dimensions of the second arm wedge member and the rectangular opening of the first arm wedge member, the degree of engagement between the two members can be controlled by the motion of the arm wedge 36. It is proposed, that in the rest position, the arm wedge is controlled into a position where the distance is reduced, but not to zero. No force is applied to the second arm wedge member by the arm wedge. It is first when the crane is deformed, that the two arms will move relative to each other, thereby twisting and locking into each other. When the crane is back in its neutral position without any loads, the two arm members will be back in their neutral positions and the locking effect will be removed. In this way, it is easy to disengage the two arms from each other when the crane is back in the neutral position. There is a risk that if a high clamping force were applied between the arms, already in the neutral position, that the two arms would clamp even stronger together during deformation, and then become locked together, and be difficult to disengage with each other.

FIG. 11 also shows an embodiment of a safety mechanism which can be used to ensure a secure connection between the jaws and the flange. In this embodiment, a displaceable pin 53 is provided at the centre of each cartridge. The displaceable pin extends parallel to the opening between opposing teeth and arranged between the centre two sets of opposing teeth of each cartridge. In this embodiment, the displaceable pin is provided with a bright colour, for example red. When the jaw is properly placed on the flange of the tower section, the displaceable pin will be pressed into the cartridge, thereby disappearing from view. Hence, the red colour of the pin will slide into the cartridge. By looking at the pin, one can easily see if the jaw is properly mounted on the flange. If the red portion is visible, the jaw is not yet positioned properly on the flange. In other embodiments, instead of a displaceable pin, a distance sensor could be used instead. A displaceable pin can also be used together with a camera when the jaws are to be used in a position where it is difficult for an operator to see the pin.

It is to be noted that the figures and the above description have shown the example embodiments in a simple and schematic manner. Many of the specific mechanical details have not been shown since the person skilled in the art should be familiar with these details and they would just unnecessarily complicate this description.

1. A crane (1) connectable to a tower (20) of a wind turbine,
wherein the tower (20) comprises a set of one or more crane connection flanges (22) fixed to and extending outwardly from an outer surface (21) of the tower (20) said crane connection flanges of said set of one or more crane connection flanges being arranged circumferentially around the tower and having upper and/or lower engagement surfaces (23),
wherein the crane (1) comprises a base portion (10), an arm (31) and at least two flange connection mechanisms (40), said arm (31) extending from the base portion (10) and at least one of said at least two flange connection mechanisms being connected to said arm,
wherein said at least two flange connection mechanisms are configured for connecting to a crane connection flange of the set of one or more crane connection flanges (22) of the tower,
wherein each of the at least two flange connection mechanisms (40) comprises two cartridges (50),
wherein each cartridge (50) comprises at least one upper flange engaging element for engaging an upper engagement surface and/or at least one lower flange engaging element for engaging a lower engagement surface (23) of a crane connection flange of the set of one or more crane connection flanges (22) of the tower;
wherein the two cartridges (50) of each flange connection mechanism (40) are separated by a distance (D1) from each other in a horizontal direction, and
wherein the flange connection mechanism comprises a vertical load balancing mechanism arranged between the two cartridges such that the vertical forces exerted by the upper and/or lower flange engaging elements of the two cartridges on a flange with which the flange engaging elements of the flange connection mechanism is connected to are the same.

2. Crane according to claim 1, characterized in that the vertical load balancing mechanism of the flange connection mechanisms comprises a main frame (45) and in that the cartridges are connected to the main frame and in that the main frame is arranged pivotably about a main frame horizontal pivot axis (A2) relative to the base portion and/or the arm (31, 32) to which the flange connection mechanism is connected, and where the main frame horizontal pivot axis (A2) of each flange connection mechanism (40) is arranged between the two cartridges (50) of the flange connection mechanism.

3. A crane (1) according to claim 1, characterized in that a cartridge of a flange connection mechanism comprises a set of flange engaging elements comprising an upper engaging element engaging an upper engagement surface and a lower engaging element engaging a lower engagement surface.

4. A crane (1) according to claim 1, wherein at least one cartridge comprises a set of two flange engaging elements which are separated from each other horizontally and wherein said cartridge comprises a vertical load balancing mechanism connected between the two flange engaging elements.

5. A crane (1) according to claim 4, characterized in that the cartridge comprising a set of two flange engaging elements comprises an additional set of two flange engaging elements and an additional vertical load balancing mechanism between the two flange engaging elements of said additional set of two flange engaging elements and in that said cartridge further comprises an additional broader vertical load balancing mechanism arranged between the two vertical load balancing mechanisms of the two sets of two flange engaging elements.

6. A crane (1) according to claim 1, characterized in that the flange engaging elements (60) of a cartridge (50), when there are more than one flange engaging elements, are arranged along a curve in a horizontal plane.

7. A crane (1) according to claim 1, characterized in that each of the two cartridges of a flange connection mechanism are pivotably connected to a main frame of the flange connection mechanism about cartridge vertical axes.

8. A crane (1) according to claim 1, characterized in that the crane further comprises an arm locking mechanism, said arm locking mechanism comprising a released state where a distal end portion of the arm is freely displaceable with respect to the base portion and a locked state where the distal end portion of the arm is locked with respect to the base portion.

9. A crane (1) according to claim 1, characterized
in that the arm is a first arm and the crane further comprises a second arm,
in that each of the first arm (31) and the second arm (32) comprises an inner link (31′, 32′) and an outer link (31″, 32″), and where each inner link (31′, 32′) and each outer link (31″, 32″) comprises a flange connection mechanism (40), and
in that the inner link and the outer link are pivotably connected to each other about vertical axes.

10. A method of connecting a crane (1) to a tower (20) of a wind turbine,
wherein the tower (20) comprises a set of one or more crane connection flanges (22) fixed to and extending outwardly from an outer surface (21) of the tower (20) the one or more crane connection flanges of said set of one or more crane connection flanges being arranged circumferentially around the tower,
wherein the crane (1) comprises a base portion (10) and an arm (31),
wherein the arm (31) comprises at least one flange connection mechanism comprising at least an upper flange engaging element and a lower flange engaging element for engaging opposed engagement surfaces (23) of the one or more crane connection flanges of the set of one or more crane connection flanges;
wherein a clamping mechanism is provided between the upper and lower flange engaging elements to adjust an opening between the upper and lower flange engaging elements;
and wherein the method comprises,
bringing the flange connection mechanism (31, 32) into the vicinity of a crane connection flange of the set of one or more crane connection flanges, such that the upper flange engaging element is arranged above the crane connection flange (22) and the lower flange engaging element (62) is arranged below the crane connection flange (22) and
adjusting the clamping mechanism such that force applied by the upper flange engaging element to the flange of the tower is at least 2 times larger or at least 2 times smaller than the force applied by the lower flange engaging element.
